(19) United States
(12) Patent Application Publication
(10) Pub. No.: US 2025/0130208 A1
(43) Pub. Date: Apr. 24, 2025

(54) SHEAR VALVE COMPENSATING FOR STATOR-ROTOR SURFACE ALIGNMENT VARIATIONS

(71) Applicant: Waters Technologies Corporation, Milford, MA (US)

(72) Inventor: Wade P. Leveille, Douglas, MA (US)

(21) Appl. No.: 18/920,001

(22) Filed: Oct. 18, 2024

Related U.S. Application Data
(60) Provisional application No. 63/591,190, filed on Oct. 18, 2023.

(51) Int. Cl. G01N 30/20; F16K 3/04; G01N 30/02

(52) U.S. Cl. CPC G01N 30/20; F16K 3/04; F16K 2200/101; G01N 2030/027; G01N 2030/202

(57) ABSTRACT

A valve for a liquid chromatography system comprises a stator; a rotor that rotates about a vertical axis relative to the stator, the rotor comprising a rotor body and a rotary shaft interface, the rotary shaft interface comprising a cavity along the vertical axis and an indentation at a bottom region of the cavity along the vertical axis; a platen in communication with a bottom surface of the rotor body, the platen having a conical feature along the vertical axis; and a ball bearing having a top portion positioned in the conical feature of the platen and a bottom portion positioned in the indentation of the rotary shaft interface allowing for pivoting of the platen relative to the vertical axis and for aligning a top surface of the rotor body to be parallel with a surface of the stator.

### PRIORITY

This application is a provisional patent application that includes the contents of U.S. Provisional Patent Application Ser. No. 63/591,190 filed Oct. 18, 2023 and titled “Shear Valve Compensating for Stator-Rotor Surface Alignment Variations,” the entirety of which is incorporated herein by reference.

### FIELD OF THE INVENTION

The disclosed technology relates generally to rotary shear valves for liquid chromatography-mass spectrometry (LC-MS) systems. More particularly, the technology relates to the compensation for non-uniform contact at a rotor-to-stator interface for a rotary shear valve.

### BACKGROUND

Rotary valves are generally used in LC-MS systems for fluidic routing to various chromatography components in a repeatable or cyclic process. Valve functions can range from solvent selection, fluid redirection, sample injection, and so on. High pressure chromatography shear valves include a rotor and a stator that form a seal at the interface between the rotor surface and stator surface to alter the flow path directions of mobile phase constituents such as solvents. However, the high pressure and temperature requirements of a rotary valve in order to provide a sufficient seal needed to provide sufficient high-performance liquid chromatography (HPLC) separation performance requires a reliable rotor-stator interface. An increased pressure force can result in increased material stress and excessive wear, which can reduce or compromise the service life of the valve, namely, the number of switching cycles. In addition, small assembly tolerances or production tolerances can result in misalignment and non-uniform contact at the interface between the rotor surface and stator surface, which can damage or impose undesirable wear and tear of the rotor and stator surfaces leading to premature failure and leaks.

To address these problems, conventional valve products generally employ a polyetheretherketone (PEEK)-based rotor or the like which can be used in applications up to 18 ksi and 50° C. However, the material properties of PEEK materials may not match the future pressure and temperature requirements of next generation LC systems, for example, greater than 25 ksi and 120° C. New materials are being considered such as stainless steel, titanium, ceramic, and tetragonal zirconia polycrystal (TZP). However, these materials exhibit hardness properties that may reduce rotor wear and life, which can be exacerbated by misalignments, angular mismatches, or the like at the rotor-stator interface due to assembly or production tolerances resulting in a poor seal due to a non-uniform pressure distribution in the interface.

There is a need for a valve having a rotor formed of a hard material such as ceramic, TZP, stainless steel (SST), titanium, etc. to accommodate minor alignment issues due to tolerances and manufacturability and form a sufficient seal at high pressure and elevated temperatures.

### SUMMARY

In one aspect, a valve for a liquid chromatography system comprises a stator; a rotor that rotates about a vertical axis relative to the stator, the rotor comprising a rotor body and a rotary shaft interface, the rotary shaft interface comprising a cavity along the vertical axis and an indentation at a bottom region of the cavity along the vertical axis; a platen in communication with a bottom surface of the rotor body, the platen having a conical feature along the vertical axis; and a ball bearing having a top portion positioned in the conical feature of the platen and a bottom portion positioned in the indentation of the rotary shaft interface allowing for pivoting of the platen relative to the vertical axis and for aligning a top surface of the rotor body to be parallel with a surface of the stator.

The valve may further comprise an o-ring about the platen in the cavity of the rotary shaft interface.

The rotor body may have a first hole at a first side of the rotor body and a second hole at a second side of the rotor body. The valve may further comprise a first pin extending from the rotary shaft interface into the first hole of the rotor body and a second pin extending from the rotary shaft interface into the second hole of the rotor body allowing the rotor body and the rotary shaft interface to rotate about the vertical axis in unison.

The first pin and the second pin may have a distal end that is inserted into the first hole and second hole, respectively, below the top surface of the rotor body.

The indentation of the platen in communication with the ball bearing may provide a fulcrum that is proximal the bottom surface of the rotor body.

The rotor may be formed of a hard material selected from a group comprising stainless steel, titanium, ceramic, and tetragonal zirconia polycrystal (TZP), metal, or glass.

The indentation of the platen may be conical, cylindrical, or spherical.

In another aspect, a valve for a liquid chromatography system comprises a stator; a rotor that rotates about a vertical axis relative to the stator, the rotor comprising a rotor body and a rotary shaft interface, the rotary shaft interface comprising a cavity along the vertical axis and conical feature at a bottom region of the cavity along the vertical axis; a platen in communication with a bottom surface of the rotor body, the platen having a conical feature along the vertical axis; and a post having a combination of a spherical and hexagonal top portion positioned in the indentation of the platen and a bottom portion positioned in the conical feature of the rotary shaft interface allowing for pivoting of the platen relative to the vertical axis and for aligning a top surface of the rotor body to be parallel with a surface of the stator.

The valve may further comprise an o-ring about the platen in the cavity of the rotary shaft interface.

The rotor body may have a first hole at a first side of the rotor body and a second hole at a second side of the rotor body. The valve may further comprise a first pin extending from the rotary shaft interface into the first hole of the rotor body and a second pin extending from the rotary shaft interface into the second hole of the rotor body allowing the rotor body and the rotary shaft interface to rotate about the vertical axis in unison.

The first pin and the second pin may have a distal end that is inserted into the first hole and second hole, respectively, below the top surface of the rotor body.

The conical feature of the platen in communication with the post provides a fulcrum that is proximal the bottom surface of the rotor body.

The rotor may be formed of a hard material selected from a group comprising stainless steel, titanium, ceramic, and tetragonal zirconia polycrystal (TZP), metal, or glass.

In another aspect, a valve for a liquid chromatography system comprises a stator; a rotor that rotates about a vertical axis relative to the stator, the rotor comprising a rotor body and a rotary shaft interface that connects the shaft to the rotor; a platen between the rotor body and the rotary shaft interface, the rotary shaft interface comprising a first cavity and the platen including a second cavity along the vertical axis; a post extending between the first cavity and the second cavity interface, the post having a combination of a spherical and a hexagon portion that matches the second cavity in the platen allowing for pivoting of the platen relative to the vertical axis and for aligning a top surface of the rotor body to be parallel with a surface of the stator.

The valve may further comprise an o-ring about the platen.

The rotor body may have a first hole at a first side of the rotor body and a second hole at a second side of the rotor body. The valve may further comprise a first pin extending from the platen into the first hole of the rotor body and a second pin extending from the platen into the second hole of the rotor body allowing the rotor body and the platen to rotate about the vertical axis in unison.

The distal end of the rotary shaft post may have flat features within the spherical portion allowing for rotational drive of the platen as well as pivoting.

The second cavity of the platen may be hexagonal in form to accept a drive portion of the post.

The rotor may be formed of a hard material selected from a group comprising stainless steel, titanium, ceramic, and tetragonal zirconia polycrystal (TZP).

In another aspect, a valve for a liquid chromatography system comprises a stator; a rotor that rotates about a vertical axis relative to the stator, the rotor comprising a rotor body and a rotary shaft interface; a platen between the rotor body and the rotary shaft interface; the platen comprises a first pin extending from the interface into the first hole of the rotor body and a second pin extending from the interface into the second hole of the rotor body allowing the rotor body and the platen interface to rotate about the vertical axis in unison; a cavity in the rotary shaft interface; a post extending from the rotary shaft interface, the post having a spherical portion and a hexagon portion at one end and a feature to match the cavity of the rotary shaft on the opposite end; the platen having a cavity to match that of the post which may have a spherical and hexagonal form; allowing for rotation of the platen about the vertical axis and for aligning a top surface of the rotor body to be parallel with the surface of the stator.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A-1C are cross-sectional views of a conventional rotary shear valve during an operation.

FIG. 2A is a cross-sectional view of a rotary shear valve, in accordance with some embodiments of the present inventive concepts.

FIG. 2B is a close-up view of the rotor of FIG. 2A.

FIGS. 3A-3C are cross-sectional views of the rotary shear valve of FIGS. 2A and 2B during an operation.

FIG. 4 is a cross-sectional view of a rotary shear valve, in accordance with another embodiment of the present inventive concepts.

FIGS. 5A-5C are cross-sectional views of the rotary shear valve of FIG. 4 during an operation.

FIGS. 6A-6C are cross-sectional views of another embodiment of a rotary shear valve during an operation.

FIG. 6D is a cross-sectional top view of an embodiment of a drive post detail used in the rotary shear valve of FIGS. 6A-6C.

FIGS. 7A-7C are cross-sectional views of another embodiment of the drive post detail used in a rotary shear valve during an operation.

FIG. 7D is a cross-sectional top view of the rotary shear valve of FIGS. 7A-7C.

FIG. 8 is a cross-sectional view of a rotary shear valve, in accordance with other embodiments of the present inventive concepts.

FIG. 9 is a cross-sectional view of a rotary shear valve, in accordance with other embodiments of the present inventive concepts.

FIG. 10 is a cross-sectional view of a rotary shear valve, in accordance with other embodiments of the present inventive concepts.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

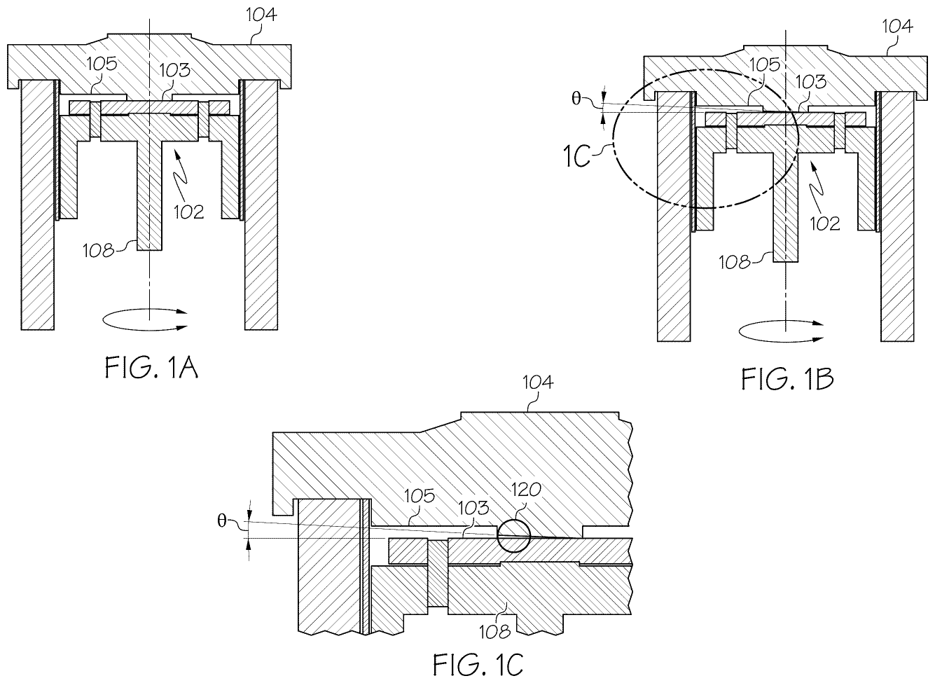

FIG. 1A-1C are cross-sectional views of a conventional rotary shear valve 100 during an operation. The rotary shear valve 100 includes a rotor 102 and a stator 104.

The stator 104 has a sealing face 105 that is constructed and arranged to directly abut a surface 103 of the rotor 102 to form a fluid-tight seal. A load can be applied to the rotor 102 to form the seal between the surfaces 103, 105, which are formed of materials suitable for forming the seal. It is desirable for the surfaces 103, 105 to be parallel. However, tolerances considered when manufacturing shear valves can give rise to undesirable non-parallel surfaces at a region 120 where the rotor surface 103 is at an angle (θ) relative to the stator 105 as shown in FIGS. 1B and 1C. A factor in ensuring parallel surfaces is that the bore in which the rotary shaft resides is perpendicular to the top face which orientates or otherwise positions the stator. During assembly, the bushing is pressed into the housing, then machined relative to the housing mounting face. Machining tolerances associated with this process may result in an imperfect housing mounting face, which may not be perpendicular to the bushing bore. This may result in an undesirable critical angle of the stator sealing face relative to the bore of the housing bushing after assembly, i.e., the angle is not 90 degrees as desired. As shown in FIG. 1B, the rotor 104 having the mismatch at region 120 due to tolerances cannot align with the stator surface 105 using its drive shaft 108, especially a rotor formed of a hard material such as ceramic, TZP, or material having similar stiffness characteristics. On the other hand, a rotor formed of a higher ductile material such as PEEK may not support the growing need for higher pressure and temperature capabilities, for example, greater than 20 ksi and 100° C., respectively.

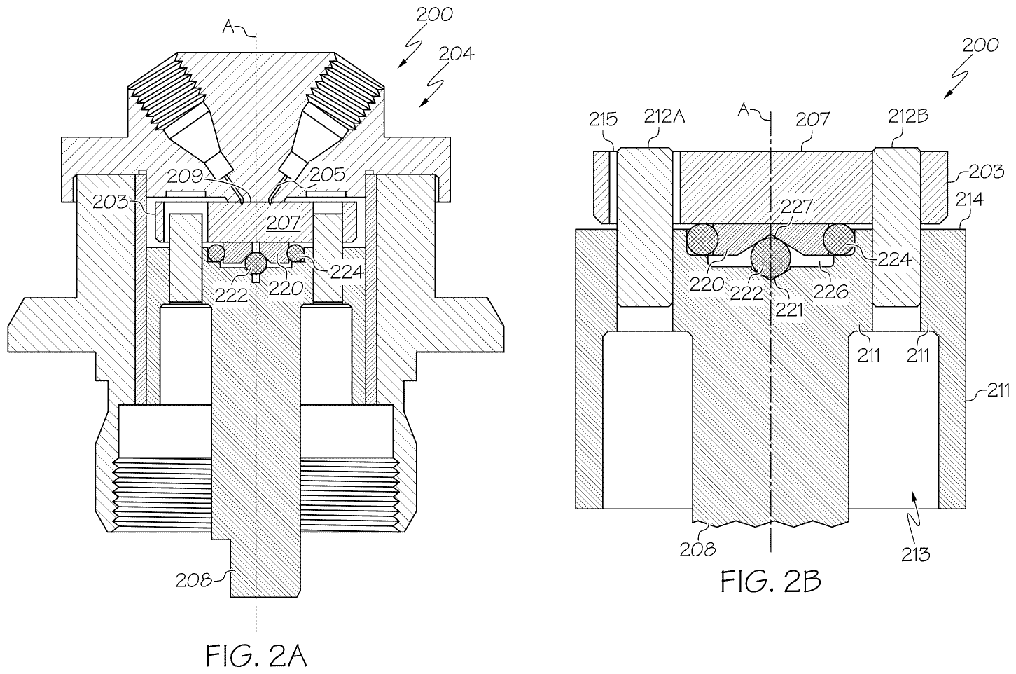

FIGS. 2A and 2B are cross-sectional views of a rotary shear valve 200, in accordance with some embodiments of the present inventive concepts. The rotary shear valve 200 includes a rotor 203 and a stator 204. The rotor 203 is constructed and arranged to rotate relative to the stator 204 about a central vertical rotor axis A.

The stator 204 includes at least one port 205, or channel or the like, that provides a fluid path between the stator 204 and the rotor 203. The stator 204 can be formed of metal such as titanium, stainless steel, TZP, and/or alloy thereof, and/or other materials such as ceramic or the like. A fluid-tight seal can be formed at an interface between the rotor 203 and stator 204 when a surface 207 of the rotor 203 is in direct contact with a surface 209 of the stator 204. An o-ring 224 described below may contribute to the fluid-tight seal in some embodiments.

In some embodiments, the rotor 203 includes a rotor body, a shaft 208, and a rotary shaft interface 211. The shaft 208 can extend from the rotary shaft interface 211 along the central vertical axis A and engage with a mechanism configured to rotatably drive the shaft 208 about the central vertical axis A. The rotary shaft interface 211 can include two or more apertures 213 configured and dimensioned to receive pins 212A, B (generally, 212) for engaging complementary apertures 215 in the rotor 203. As shown, the apertures 213 may have different dimensions such as width, diameter, or the like along their lengths. For example, a portion of the apertures 213 aligned with the rotor apertures 215 may have a smaller width than a portion of the apertures 213 at a bottom region of the interface 211. When inserted in the respective apertures, the pins 212 can detachably interlock shaft 208 with the rotor 203. Thus, as the shaft 208 axially rotates about the central vertical axis A, the pins 212 engage the apertures 215 in the rotor 203 to simultaneously axially rotate the rotor 203 relative to the stator 204. In some embodiments the shaft 208 has a ratio (L/D) of a length (L) defined between bearings of the rotary shaft 208 to a diameter (D) that further contributes to axial alignment, for example, an L/D of 1.4 but not limited thereto.

In some embodiments, a distal end of the rotary shaft interface 211 is proximal to the rotor body 203 has a cavity 226, or first groove, indentation, bore, hole, or the like along the axis A. The cavity 226 can be configured to receive a platen assembly 220, a spherical element 222 such as a ball, and an o-ring 224, collectively forming a compensation alignment assembly. In some embodiments, the o-ring 224 is not part of the compensation alignment assembly. In some embodiments, as shown in FIGS. 2A and 2B, the cavity 226 has a first dimension such as a width, circumference, or the like sufficient for receiving the platen assembly 220 and ball 222, or ball bearing, and a second dimension that is greater than the first dimension into which the o-ring 224 about the platen assembly 220 is positioned. The second dimension may have a height less than a width of the o-ring 224 so that a portion of the o-ring 224 is higher than the surface 214 of the interface 211 and for directly abutting the rotor body 203. In some embodiments, the o-ring 224 has elastomeric properties and may be formed of elastomeric compounds such as Viton, Nitrile, Fluorine Kautschuk Material (FKM) or related fluoroelastomer, or the like.

In some embodiments, the ball 222 is positioned in a conical feature 221, e.g., a pocket, indentation, bore, hole or the like formed by a drill point of a drill bit or other tool in a center region of the cavity 226 of the rotary shaft interface 211. The conical feature 221 allows for the ball 222 to pivot, rotate, or otherwise move between the interface 211 and the platen assembly 220. The spherical surface of the ball 222 produces a pivot point, or fulcrum. The ball 222 may be formed of a hard material such as 440C steel but not limited thereto. In some embodiment, the material of the ball 222 is harder or stiffer than the material forming the platen 220. In some embodiments, the ball 222 has a 5/64″ diameter but not limited thereto. The platen assembly 220 may have an indentation 227, or groove, bore, hole, or the like for communicating with a top portion of the ball 222 while the bottom portion of the ball 222 is positioned in the conical feature 221 of the interface 211. The conical feature 221, ball 222, and indentation 227 may extend along the axis A. The ball 222 sandwiched between the platen assembly 220 and the interface 211 may allow a gap to be present between the platen assembly 220 and the interface 211 inside the cavity 226.

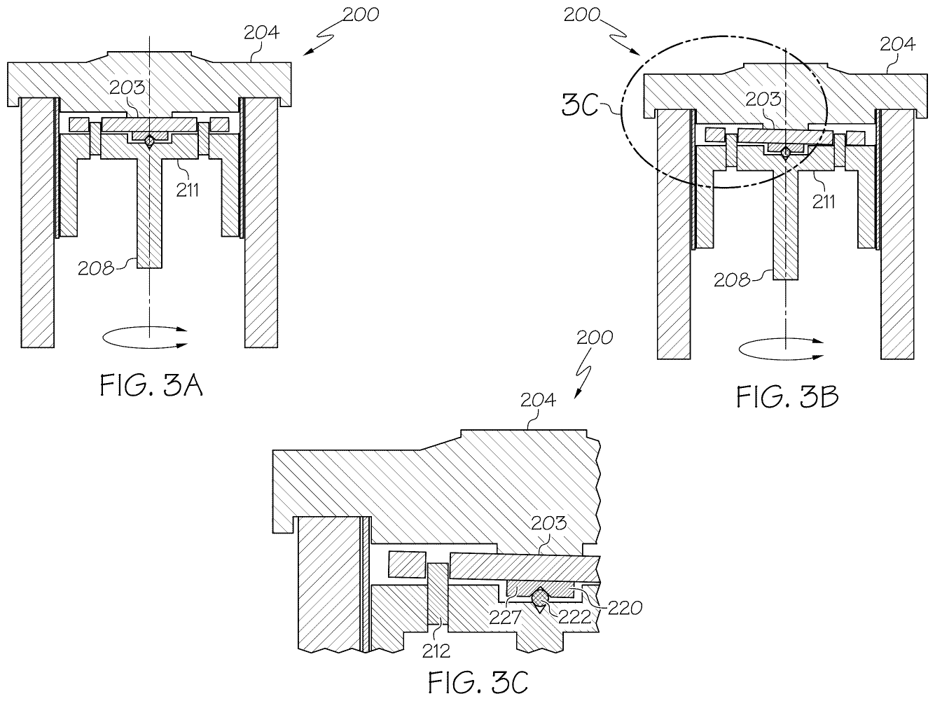

The platen assembly 220 contacts the underside of the rotor 203 and, as shown in FIGS. 3A-3C can provide adjustments about the axis A. The platen assembly 220 rotates together with the pins 212. More specifically, the platen assembly 220 rotates in unison with the rotor and rotary shaft. Here, the geometry, e.g., coned or spherical, of the platen indentation 227 is positioned on the ball 222 allowing for axial rotation of the platen assembly 220 and allowing the top surface 207 of the rotor to align with the bottom surface 209 of the stator 204.

During operation, a load, e.g., a compressive force, is axially applied to the rotary shaft interface 211 of the shaft 208 and the force is transferred to the ball 222. The platen assembly 220 acts as an intermediate device between the rotor and a fulcrum formed by the ball 222, allowing for pivoting of the rotor body 203, or more specifically, the surface 207 of the rotor body 203 to align with the planer surface 209 of the stator 204. the pivot point, or fulcrum is positioned to allow the platen assembly 220 to rotate or adjust at or proximal to the underside of the rotor surface 207. Also, the platen surface serves to minimize the contact stress on the rotor surface 207.

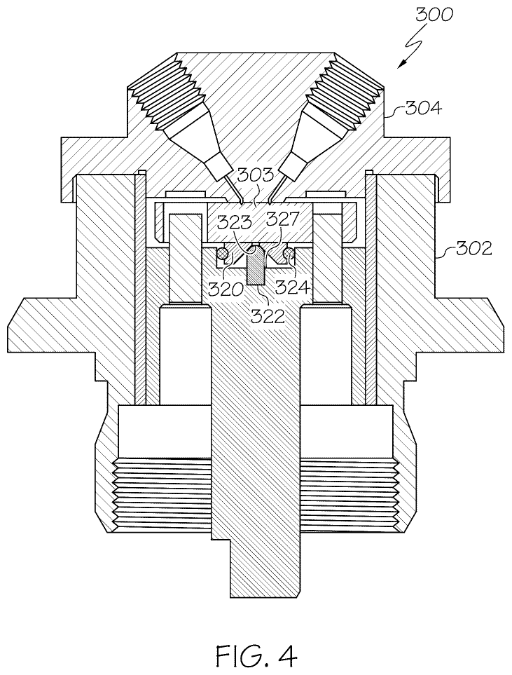

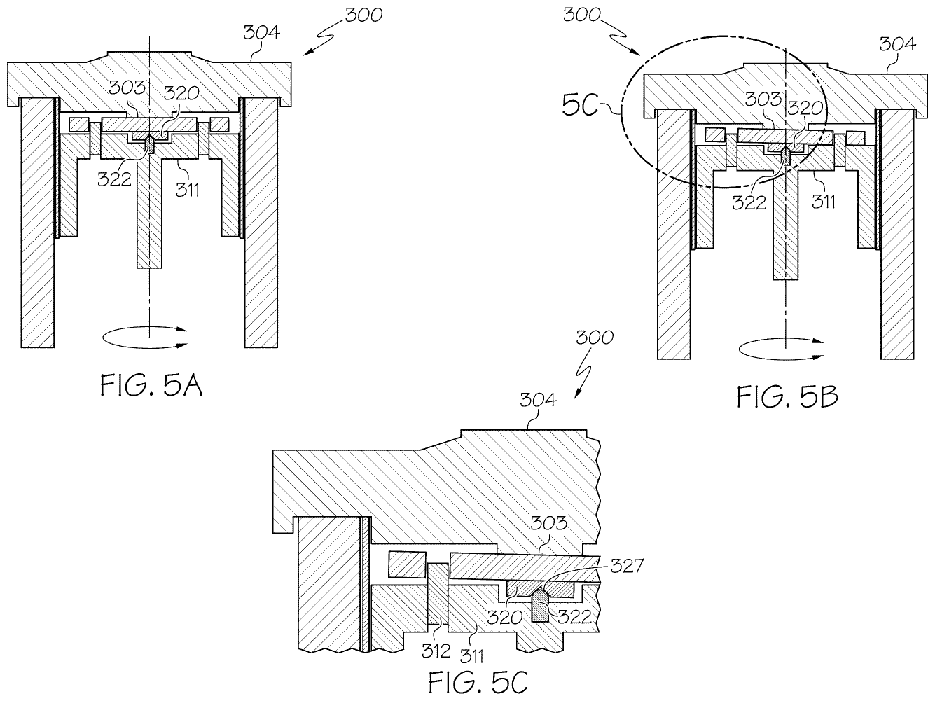

FIG. 4 is a cross-sectional view of a rotary shear valve 300, in accordance with another embodiment of the present inventive concepts. FIGS. 5A-5C are cross-sectional views of the rotary shear valve 300 of FIG. 4 during an operation. The rotary shear valve 300 includes a rotor body 303 and a stator 304, which may be similar to or the same as the rotor 203 and stator 204 of FIG. 2 except for the following. The rotor 303 can be positioned in a bore of a housing bushing 302 so that the stator sealing face directly abuts the rotor surface. Repetitive details of the rotor 303 and stator 304 are therefore omitted for brevity.

The rotary shear valve 300 includes a post 322 with a spherical top surface 323 instead of a ball bearing or other spherical element.

In this embodiment, the platen 320 has an indentation 327 having a conical, cylindrical, or spherical feature on its underside of the platen 320. The top surface of the platen 320 contacts the underside of rotor body 303. The platen 320 rests on the spherical surface 323 of the post 322. The post 322 allows the platen 320 to axially adjust or align such that the top surface of the rotor 303 and bottom surface of the stator 304 align.

In some embodiments, the maximum angular alignment of the rotary shear valves of FIGS. 2-5 is limited by the pin-to-rotor clearance. In particular, the drive pins 212 are coupled to or integral with the drive shaft, or more specifically, the interface 211 which rotates. The rotor 203 is positioned above the drive shaft 208 and interface 211, which has a rotor hole, or aperture 215, for receiving the pins 212. There is a relationship between at least one rotor hole 215 and its corresponding pin 212. In particular, there may be a clearance, for example, 0.0005 inches. If the clearance is too large then rotational alignment issues might arise such that the fluidic passage hole in the rotor 203 may not align with the fluidic passage hole in the stator 204.

To mitigate the foregoing, the ball 222 (FIGS. 2-3) or spherical surface 323 of the pin 322 (FIGS. 4-5) may produce a pivot point or fulcrum at the indentation 227, 327 of the platen assembly 220, 320, respectively. In preferred embodiments, the pivot point is at or proximal to the rotor surface because the clearance, or gap, between the pin and rotor hole may impose limitations on the angular alignment or compensation or adaptability, or the maximum angle that the rotor body can tilt toward the interface due to the presence of the pins and the limited clearance between the pins and the rotor holes in which the pins are positioned.

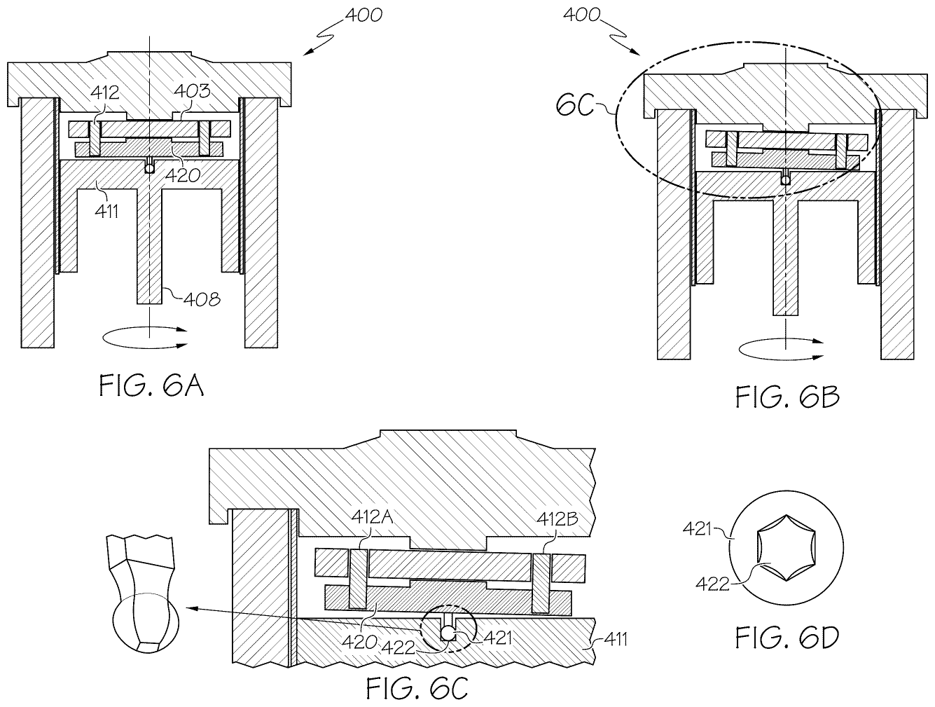

FIGS. 6A-6C are cross-sectional views of another embodiment of a rotary shear valve 400 during an operation. FIG. 6D is a view of a drive post of FIGS. 6A-6C.

Here, the angular constraints created by the tolerance of pin-to-hole are removed because the pins 412 extend only between the platen 420 and rotor body 403, and do not engage with the drive shaft interface 411. Since the platen 420 incorporates the pins 412, the rotor body 403, pins 412, and platen 420 move together in a unitary manner.

However, a new problem emerges in that a mechanism is required to rotate the platen 420 in view of the pins 412 not coupled to or otherwise in communication with the rotor drive shaft 408, or more specifically, the interface 411 while also allowing for axial adjustment and rotation. To address this, in some embodiments, as shown in FIG. 6D, a post 419 having a ball hex end 422 received by the hex shaped cavity 421 in the interface 411 of the rotor drive shaft 408.

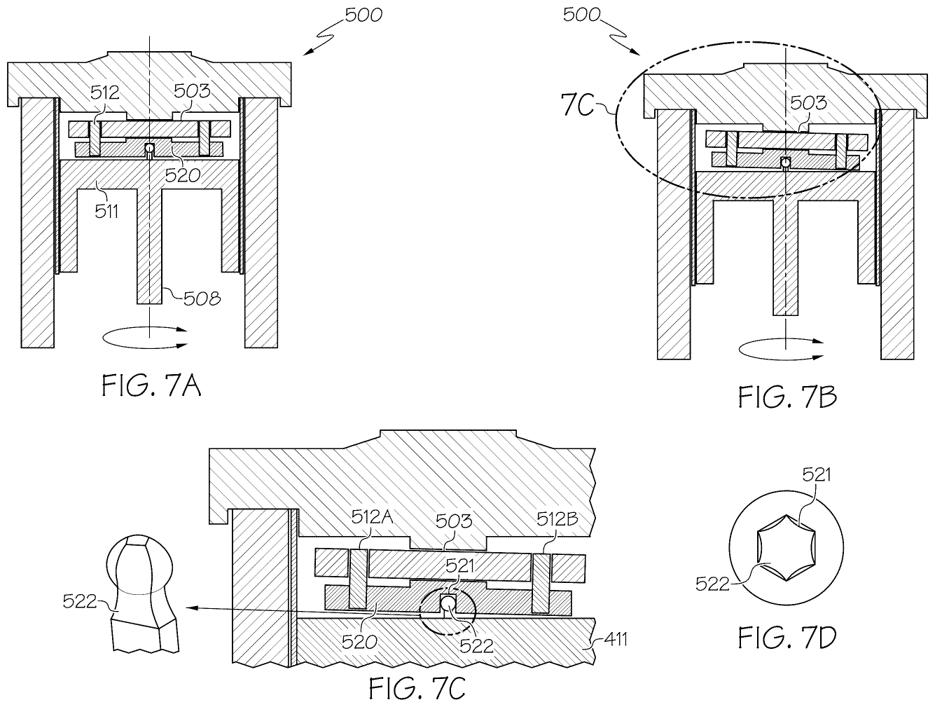

FIGS. 7A-7C are cross-sectional views of another embodiment of a rotary shear valve 500 during an operation. FIG. 7D is a view of a drive post of FIGS. 7A-7C. As shown, a post has a proximal end coupled to and extending from the interface 511 of a rotor drive shaft 508 and has a ball hexagon (“hex”) end 522 at its distal end that is received by the hex shaped cavity 521 in the platen 520, which is opposite the configuration of FIGS. 6A-6D, where the ball hex end 422 of the post is inserted into a hex shaped cavity in the rotor drive shaft interface 411. This permits the pivot/fulcrum to be closer to the surface of the rotor body 503 than that of the rotor 403 of FIGS. 6A-6C.

FIG. 8 is a cross-sectional view of a rotary shear valve 600, in accordance with other embodiments of the present inventive concepts. The rotary shear valve 600 includes a rotor drive shaft interface cavity 626 and optional o-ring 624 similar to those of the rotary shear valve 200 of FIGS. 2A and 2B. Details are therefore omitted for brevity. However, the rotary shear valve 600 has a platen 620 including a semispherical or concave element 622 extending from a central region of the platen 620 along the central vertical axis A about which the rotor 602 rotates. In some embodiments, the semispherical element 622 and platen 620 are integral and unitary, for example, formed of a same machined stock. In other embodiments, the semispherical element 622 and platen 620 are formed separately, and coupled together by adhesive, welding, or other coupling material and/or technique.

FIG. 9 is a cross-sectional view of a rotary shear valve 700, in accordance with other embodiments of the present inventive concepts. The rotary shear valve 700 includes a rotor drive shaft interface cavity 726, ball 722, and optional o-ring 724 similar to those of the rotary shear valve 200 of FIGS. 2A and 2B. Details are therefore omitted for brevity. However, the contact surface between the ball 722 and hard rotor support is different than that shown in FIG. 2. In particular, the platen 720 has an indentation 727, or slot, bore, hole, or the like for receiving at least a top portion of the ball 722 while the bottom portion of the ball 722 is positioned in the groove 721 of the rotor drive shaft interface 711. The indentation 727 is not conical as is the indentation 227 of the valve 200 of FIG. 2. Instead, the indentation 727 has vertical sidewalls separated by a distance that is the same as or greater than the diameter of the ball 722.

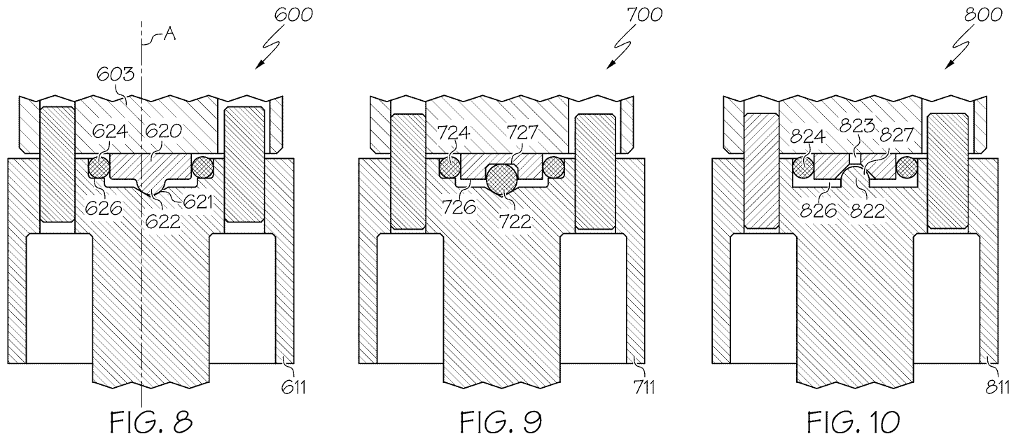

FIG. 10 is a cross-sectional view of a rotary shear valve 800, in accordance with other embodiments of the present inventive concepts. The rotary shear valve 800 includes a rotor drive shaft interface cavity 826 and optional o-ring 824 similar to those of the rotary shear valve 200 of FIGS. 2A and 2B. Details are therefore omitted for brevity. However, the rotary shear valve 800 has a rotor drive shaft interface 811 including a semispherical or concave element 822 extending from a central region of the interface 811 along the central vertical axis A about which the rotor 602 rotates, where the element 822 mates with an indentation 827 in the platen 820. In some embodiments, the semispherical element 622 and interface 811 are integral and unitary, for example, formed of a same machined stock. In other embodiments, the semispherical element 822 and interface 811 are formed separately, and coupled together by adhesive, welding, or other coupling material and/or technique. In some embodiments, the platen 820 has a thru-hole 823 for machining or otherwise forming the indentation 827, which may be tapered, conical, cylindrical, spherical, or the like.

As described above, the clearance between the pin and rotor hole may impose limitations on the rotational alignment between the rotor body and interface, which in turn can prevent the top surface of the rotor from being parallel with the bottom surface of the stator. On the other hand, an excessive clearance to increase the maximum rotational alignment can result in a misalignment between the fluidic passage hole in the rotor and the fluidic passage hole in the stator.

As described above, embodiments of a rotary shear valve include two drive pins coupled to or integral with a drive shaft and that extend into holes or slots in the rotor body for rotating the rotor relative to the stator. The clearance between the hole and pin may be insufficient with respect to allowing alignment to occur between the fluidic passage hole in the rotor and the fluidic passage hole in the stator. In turn, the maximum permissible alignment angle (θ) (e.g., see FIG. 1C) is reduced by this lack of clearance. Therefore, in accordance with embodiments of the present inventive concept, e.g., described in FIGS. 2-10 it is preferable that the pivot point is as close to the rotor surface as possible.

In some embodiments, a valve, e.g., described above, has first and second dowel pins, e.g., similar to those in FIGS. 6A-7D, at a maximum material condition (MMC) and a predetermined height above the rotary shaft surface, in this example, 0.16 inches. Both rotor holes are formed at the MMC. The total clearance of pin to the rotor hole is 0.0005 inches. Accordingly, the geometry at an alignment angle (θ)=0 degrees allows for a 0.00025 inch radial clearance around the pin. The rotor thickness is 0.144 inches. In this example, a clearance of 0.0005″, or 0.00025″ radial clearance around the pin and a rotor that is 0.144″ thick can permit a maximum angle of 0.2 degrees, i.e., Arctan (0.0005/.1440)=) 0.199° (˜0.2°. However, the geometry at an alignment angle (θ)=0.1 degrees allows for radial interference of 0.00014 inches from the pin to rotor hole. The valve may be similar to the valve 300 in FIGS. 6A-6C except the angle of the shown in FIGS. 6A-6C is changed from 0 degrees to 0.1 degrees to illustrate that the pin contacts the hole on one side. The valve in the embodiments can permit the angle from 0.1° to further increase to 0.2° or more, for example, to a maximum of 2°, at which point the rotor could slide toward the left to use up all the clearance. Another difference is that an elongated element extends from the rotor instead of a platen, which allows for a swivel point or fulcrum that is proximal the bottom surface of the rotor.

In another example, a valve can have a reduced pin engagement within the rotor. As compared to the previous example, the pin engagement is reduced from 0.144 inches to 0.080 inches, which is approximately 0.090 inches above the rotary shaft surface. Here, the maximum angle is determined to be Arctan (0.0005/0.080)=0.36 degrees, which allows for a greater angular ability before pin to rotor interference occurs.

In another example, a valve can include an elongated element that is increased as compared to that of the valve in the previous example. In other embodiments having pin arrangements, the rotor can be increased to an angle of 0.3° at which point the shorter pin and rotor begin to contact and thus prevent further rotation. In these embodiments, the pivot point moves away from the surface of the rotor, so that contact occurs sooner and thus reduces angular compensation of the system. However, the valve in this example has the longer elongated element to extend the pivot point down the length of the interface, regardless of ball or sphere diameter, which translates to a greater horizontal change in distance. For example, the dowel pins can be 0.09″ above the surface of the rotary shaft interface and the element can extend 0.200″ below the rotor surface, which permits a greater horizontal change in distance, than the element in the previous example, which in this example is 0.05 inches below the rotor surface.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A valve for a liquid chromatography system, comprising:
a stator;
a rotor that rotates about a vertical axis relative to the stator, the rotor comprising a rotor body and a rotary shaft interface, the rotary shaft interface comprising a cavity along the vertical axis and an indentation at a bottom region of the cavity along the vertical axis;
a platen in communication with a bottom surface of the rotor body, the platen having a conical feature along the vertical axis; and
a ball bearing having a top portion positioned in the conical feature of the platen and a bottom portion positioned in the indentation of the rotary shaft interface allowing for pivoting of the platen relative to the vertical axis and for aligning a top surface of the rotor body to be parallel with a surface of the stator.

2. The valve of claim 1, further comprising an o-ring about the platen in the cavity of the rotary shaft interface.

3. The valve of claim 1, wherein the rotor body has a first hole at a first side of the rotor body and a second hole at a second side of the rotor body, wherein the valve further comprises a first pin extending from the rotary shaft interface into the first hole of the rotor body and a second pin extending from the rotary shaft interface into the second hole of the rotor body allowing the rotor body and the rotary shaft interface to rotate about the vertical axis in unison.

4. The valve of claim 3 wherein the first pin and the second pin have a distal end that is inserted into the first hole and second hole, respectively, below the top surface of the rotor body.

5. The valve of claim 1, wherein the conical feature of the platen in communication with the ball bearing provides a fulcrum that is proximal the bottom surface of the rotor body.

6. The valve of claim 1, wherein the rotor is formed of a hard material selected from a group comprising stainless steel, titanium, ceramic, and tetragonal zirconia polycrystal (TZP), metal, or glass.

7. A valve for a liquid chromatography system, comprising:
a stator;
a rotor that rotates about a vertical axis relative to the stator, the rotor comprising a rotor body and a rotary shaft interface, the rotary shaft interface comprising a cavity along the vertical axis and conical feature at a bottom region of the cavity along the vertical axis;
a platen in communication with a bottom surface of the rotor body, the platen having a conical feature along the vertical axis; and
a post positioned in the conical feature of the platen and a bottom portion positioned in the conical feature of the rotary shaft interface allowing for pivoting of the platen relative to the vertical axis and for aligning a top surface of the rotor body to be parallel with a surface of the stator.

8. The valve of claim 7, further comprising an o-ring about the platen in the cavity of the rotary shaft interface.

9. The valve of claim 7, wherein the rotor body has a first hole at a first side of the rotor body and a second hole at a second side of the rotor body, wherein the valve further comprises a first pin extending from the rotary shaft interface into the first hole of the rotor body and a second pin extending from the rotary shaft interface into the second hole of the rotor body allowing the rotor body and the rotary shaft interface to rotate about the vertical axis in unison.

10. The valve of claim 9, wherein the first pin and the second pin have a distal end that is inserted into the first hole and second hole, respectively, below the top surface of the rotor body.

11. The valve of claim 7, wherein the conical feature of the platen in communication with the post provides a fulcrum that is proximal the bottom surface of the rotor body.

12. The valve of claim 7, wherein the rotor is formed of a hard material selected from a group comprising stainless steel, titanium, ceramic, and tetragonal zirconia polycrystal (TZP), metal, or glass.

13. The valve of claim 7, wherein the post has a combination of a spherical and hexagonal top portion that mates with the conical feature of the platen.

14. A valve for a liquid chromatography system, comprising:
a stator;
a rotor that rotates about a vertical axis relative to the stator, the rotor comprising a rotor body and a rotary shaft interface that connects a shaft to the rotor;
a platen between the rotor body and the rotary shaft interface, the rotary shaft interface comprising a first cavity and the platen including a second cavity along the vertical axis;
a post extending between the first cavity and the second cavity, the post having a combination of a spherical and hexagon portion that matches the second cavity in the platen and allowing for pivoting of the platen relative to the vertical axis and for aligning a top surface of the rotor body to be parallel with a surface of the stator.

15. The valve of claim 14, further comprising an o-ring about the platen.

16. The valve of claim 14, wherein the rotor body has a first hole at a first side of the rotor body and a second hole at a second side of the rotor body, wherein the valve further comprises a first pin extending from the platen into the first hole of the rotor body and a second pin extending from the platen into the second hole of the rotor body allowing the rotor body and the platen to rotate about the vertical axis in unison.

17. The valve of claim 14, wherein the distal end of the of the rotary shaft post has flat features within the spherical portion allowing for rotational drive of the platen as well as pivoting.

18. The valve of claim 14, wherein the second cavity of the platen is hexagonal in form to accept a drive portion of the post.

19. The valve of claim 14, wherein the rotor is formed of a hard material selected from a group comprising stainless steel, titanium, ceramic, and tetragonal zirconia polycrystal (TZP).
